(19) United States
(12) Patent Application Publication
(10) Pub. No.: US 2006/0203352 A1
(43) Pub. Date: Sep. 14, 2006

(54) Method and apparatus for recycling reflected light in optical systems as e.g. projection display

(76) Inventor: Michael D. Pashley, Cortlandt Manor, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/539,974

(22) PCT Filed: Jun. 21, 2004
(86) PCT No.: PCT/IB04/50945

§ 371 Date: Jun. 19, 2005

Related U.S. Application Data
(60) Provisional application No. 60/482,100, filed on Jun. 24, 2003.

(51) Int. Cl. G02B 27/14

(52) U.S. Cl. 359/634

(57) ABSTRACT

An optical system (100, 200) and method of use includes at least one light source (105, 106, 107, 211, 302), each of which transmit light substantially of a particular wavelength range in a substantially randomly polarized state or an unpolarized state. The optical system (100, 200) includes a reflective polarizer (108, 204, 305) coupled to the light source, and an element (101, 102, 103, 201, 202, 203, 301) that redirects the reflected light through the light source and onto the reflective polarizer. Illustratively there is substantially no optical distance between the light source (105, 106, 107, 211, 302) and the element (101, 102, 103, 201, 202, 203, 301). An optical package, which recycles reflected light is also disclosed.

Liquid crystal (LC) technology has been applied in projection displays for use in projection televisions, computer monitors, point of sale displays, and electronic cinema to mention a few applications.

A more recent application of LC devices is the reflective LC display on a silicon substrate. Silicon-based reflective LC displays often include an active matrix array of complementary metal-oxide-semiconductor (CMOS) transistors/switches that are used to selectively rotate the axes of the liquid crystal molecules. As is well known, by application of a voltage across the LC cell, the plane of polarization of the reflected light is selectively rotated. As such, by selective switching of the transistors in the array, the LC medium can be used to modulate the light with image information. This modulated light can then be imaged on a screen by projection optics thereby forming the image or ‘picture.’

In many LCD systems, the light from a source is selectively polarized in a particular orientation prior to being incident on the liquid crystal material. This is often carried out using a polarizer between the light source and the liquid crystal. As can be appreciated, this type of system will result in a significant loss of light. For example, in a system where the light is randomly polarized or unpolarized, half of the light energy is not transmitted to the liquid crystal, and is therefore, lost. Such inefficiency can have deleterious effects on the image displayed. For example, losses in light energy can result in reduced brightness.

What is needed, therefore, is an LC apparatus that overcomes at least the deficiencies described above.

In accordance with an embodiment, an optical system includes at least one light source, each of which transmit light substantially of a particular wavelength or wavelength range of a substantially randomly polarized state or an unpolarized state. The optical system includes a reflective polarizer coupled to the light source, and an element that redirects the reflected light through the light source and onto the reflective polarizer. Illustratively there is substantially no optical distance between the light source and the element.

In accordance with another embodiment, a method of recycling light to improve efficiency of an optical system includes providing at least one reflective polarizer and at least one source of unpolarized or randomly polarized light, where one of the reflective polarizers is coupled to each of the sources of unpolarized or randomly polarized light. The method also includes redirecting light reflected from the reflective polarizer through the light source and back to the reflective polarizer, which transmits light of a particular polarization state and reflects the remaining light to the element. Illustratively, there is substantially no optical distance between the reflective polarizer and the element.

In accordance with another embodiment, an optical package includes a light-emitting element, which is encased in an optical element. The optical element redirects light reflected from one end of the element back through the light emitting device and out from the one end. Illustratively, the light-emitting element emits randomly polarized light or unpolarized light over a substantially finite wavelength range.

The invention is best understood from the following detailed description when read with the accompanying drawing figures. It is emphasized that the various features are not necessarily drawn to scale. In fact, the dimensions may be arbitrarily increased or decreased for clarity of discussion.

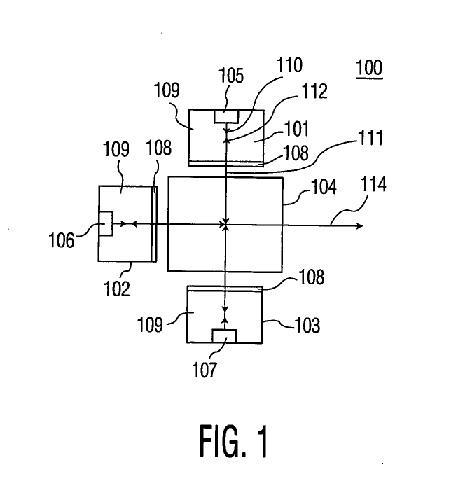

FIG. 1 is a schematic view of an optical system in accordance with an example embodiment.

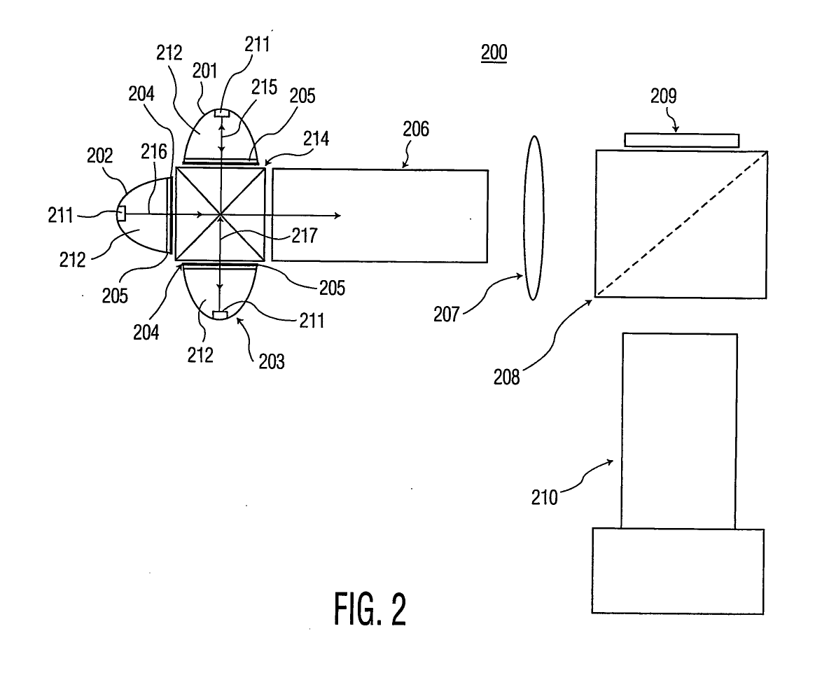

FIG. 2 is a schematic view of an optical system in accordance with another example embodiment.

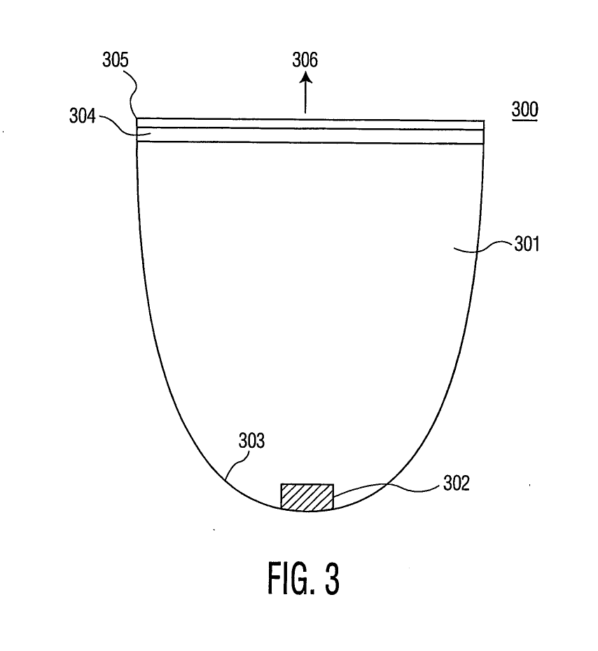

FIG. 3 is a cross-sectional view of an optical element having a light-emitting element in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

FIG. 1 shows an optical system 100 in accordance with an example embodiment. The optical system 100 includes a first optical element 101, a second optical element 102, a third optical element 103 and an optical device 104, which combines the light from the first, second and third optical elements. Illustratively, the optical device 104 is a dichroic cube, which is a device well known to one of ordinary skill in the art, and may be used to combine light of differing wavelengths.

It is noted, however, that in addition to the dichroic cube, other elements may be used to combine the light from the optical elements in the configuration shown in FIG. 1 as well as in other configurations in keeping with the example embodiments. For example, it may be useful to include dichroic elements in series to combine the light from various sources having different emission wavelengths/wavelength ranges. Moreover, it may be useful to have two dichroic elements in series to combine the light from two sources of light having different emission wavelength ranges, and a third dichroic element at an angle thereto to combine light of a third wavelength range from a third optical source with the light from the first two sources. Of course, these examples are intended to be merely illustrative, and not limiting of the example embodiments. For example, applying the referenced principles, it is possible to combine light from more than three light sources, each of which emit light of a different wavelength range, using such dichroic elements suitably chosen and arranged.

The optical elements 101, 102 and 103 include light-emitting elements, 105, 106, and 107, respectively. In addition, the optical elements 101, 102 and 103 each include a light re-director (LRD) 109, the function of which is explained in further detail herein. Illustratively, the optical elements 105, 106 and 107 may be light emitting diodes (LED's) or an array thereof that emit light over a finite wavelength range. For example, full width half-maximum (FWHM) emission wavelength range of the LED's is approximately 20 nm to approximately 40 nm. Moreover, it is noted that the use of LED's as the light-emitting elements, 105, 106, and 107, is illustrative of the embodiments. To wit, other optical sources that emit randomly polarized or unpolarized light over a certain wavelength band, or at a single wavelength may be used. In general, the emission spectra of the light-emitting elements 105, 106, 107 is a certain range about a center wavelength, with the emitted light being randomly polarized or unpolarized.

In the embodiments described thus far, the emission wavelength ranges of the individual optical elements 101, 102, and 103 differ from one another. Of course, this is effected by having each optical element 101,102, 103 have one or more light emitting devices, which emit light over a particular wavelength range that differs from the wavelength ranges of the light emitted by the light emitting devices of the other optical elements. Moreover, within any one (or more) of the optical elements 101, 102, 103, there may be light emitting devices that emit light of different wavelength bands. This may be implemented to slightly broaden the spectral width of one of the color primaries. Of course, this could be implemented using a plurality of LED's, which emit light over desired wavelength ranges.

Finally, as alluded to above, each optical element 101-103 may have more than one light-emitting element. For example, each optical element may comprise several LED chips of nominally the same emission wavelength range in order to increase the lumen output of the overall source. Of course, different configurations are possible. For example, multiple chips may be disposed within one LRD(109) or an array of chips may be disposed in an LRD, where the output of the array aligns with one face of the dichroic cube (optical device 104). The LED's may be as described in U.S. Provisional Application Ser. No. 60/435,245 entitled ‘Apparatus and Method for Illuminating a Rod’ filed Dec. 20, 2002, and specifically incorporated herein by reference.

In an example embodiment, the light-emitting elements 105-107 each include a reflective polarizer 108 that transmits light of a particular state of linearly polarized light, and reflects all other light. For example, if the polarization axis of the reflective polarizer is oriented parallel to s-polarized light, this light will be transmitted, and substantially all p-polarized light will be reflected. Beneficially, the reflective polarizers 108 are in direct contact with the LRD 109. For example, the reflective polarizers 108 may be formed directly on the surface of the LRD 109 as shown. Alternatively, an element such as a quarter-wave plate may be disposed between the LRD 109 and the reflective polarizer. Moreover, the reflective polarizer 108 may be separated from the LRD 109. This alternative may be used, but reflective losses from the reflective polarizer should be minimized as much as possible. In this case, the optical,distance between the polarizer 108 and the LRD 109 should be small compared to the diameter of the output face of the LRD 109, with air (or other suitable transparent medium) in between. It is further noted that the LRD 109 could have a reflective surface and a refractive surface such as a lens at the output face adjacent the polarizer 108. The reasons for including this reflective polarizer and the quarter-wave plate, as well as the placement of the reflective polarizer will become clearer as the present description continues.

In accordance with an example embodiment, the LRD 109 is a compound parabolic concentrator (CPC), a known device to one of ordinary skill in the art, which is described in further detail herein. This is merely illustrative, as other optical elements may be used to meet the desired characteristic function of the LRD 109 of the example embodiments. To this end, an optical element that results in a narrower angular distribution of the light while at the same time returning the reflected light back to the source may be used as the LRD 109. For example, the collimators as described in U.S. Pat. No. 6,457,423 may be used. The disclosure of this patent, which is assigned to the present assignee, is specifically incorporated herein by reference. Additionally, in an example embodiment, the reflective polarizer 108 is a wire grid polarizer. Alternatively, the reflective polarizer 108 may be a dielectric stack polarizer or similar interference-based polarizer that reflects all but a selected wavelength. Finally, the QWP 113 may be a dielectric stack polarizer, a crystal polarizer or similar retarder. It is noted that the various illustrative elements are intended to be examples of devices useful in carrying the embodiments, and are not intended to limit the metes and bounds of the embodiments.

The description of the traversal of light emitted from the first optical element 101 will be described in detail presently. The descriptions of the traversal of light in the system 100 from the second optical element 102 and the third optical element 103 are substantially identical to the description of light from the first optical element traversing the optical system 100, and are omitted in the interest of brevity and clarity of description.

The light-emitting device 105 emits light 110 over a finite wavelength range or of substantially a single wavelength. This light 110 is substantially unpolarized or randomly polarized and is incident on the far surface of the LRD 109 and the reflective polarizer 108. Light that is having its electric field vector oriented in a direction parallel to the polarization axis of the reflective polarizer 108 is transmitted through the reflective polarizer 108 as transmitted light 111, and light having its electric field vector oriented orthogonally to the polarization axis of the reflective polarizer 108 is reflected back as reflected light 112.

The LRD 109 redirects the reflected light 112 back toward the light-emitting device 105. Characteristically, the LRD 109 redirects light reflected by the reflective polarizer 108 to the light emitting element 105, and fosters the recycling of this reflected light. Some of the reflected light 112 traverses the light emitting element 105, is redirected and is transmitted as light 110. Some of the reflected light 112 is redirected by the LRD 109 and does not traverse the light-emitting device 105, and is incident on the reflective polarizer 108. Thereby, the LRD 109 is useful in ‘recycling’ the reflected light 112 from the reflective polarizer 108 back to the reflective polarizer.

In the example embodiment in which the light-emitting element is an LED, at least a portion of the redirected light is absorbed through recombination, and is re-emitted by the LED as unpolarized light 110. It is noted however that the LED will not reabsorb a significant fraction of this light, either because the light traverses the LED and is redirected (e.g., reflected) at the rear-surface of the LED 105 (e.g., by the LRD 109), or does not traverse the LED and is merely redirected (e.g., reflected) by the LRD 109.

The reflected photons that are reabsorbed by the LED 105 are reemitted by the LED 105 as unpolarized light, and are incident on the reflective polarizer 108. The reflected light that is not absorbed by the LED and is redirected by the LRD 109 also is incident on the reflective polarizer 108. Again the light that has its polarization state in parallel with the polarization axis of the reflective polarizer is transmitted and the remaining light is reflected as described. This process continues, and in essence, the light that is not transmitted through the reflective polarizer is ‘recycled’ via this process. As such, but for the LRD 109 light energy that would have been lost as reflected light from the reflective polarizer 108, is at least partially recaptured and retransmitted as light 111, increasing the efficiency of the optical system 100.

In the event that the reflected light 112 is not reabsorbed and re-emitted by the LED; or its polarization state is unchanged after reflection by the reflective polarizer, its state of polarization is orthogonal to the polarization axis of the reflective polarizer. Unless its state of polarization is transformed to be parallel to that of the axis of the polarizer, this light is again reflected by then reflective polarizer 108. Optionally, in order to transmit at least a portion of this light, a quarter wave plate (QWP) 113 may be disposed between the reflective polarizer 108 and the LRD 109. Thereby, after traversing the QWP 113 twice, the polarization state of the light, which emerges from the reflective polarizer 108 in an orthogonal polarization state, is transmitted by the reflective polarizer 108 after recycling as described above.

Light that is transmitted by the reflective polarizer 108 is incident on the element 104. It is noted that the second and third optical elements 102 and 103 also contribute a polarized optical signal to the output signal 114. The light emitted from each of the optical elements 101, 102, and 103 has the same polarization. Moreover, output signal 114 may be three output signals (one from each optical element), which emerge from the element 104, each being polarized, and each having a particular wavelength range that may not be the same as that of either of the other output signals.

As referenced previously, the optical element 104 illustratively is a dichroic cube that combines three beams of different wavelengths from optical elements 101-103 having. The final mixed output beam (output beam 114) has a substantially defined polarization. Moreover, it is also possible to combine light from more than three optical sources, each of which emits light over a different wavelength range, or at a different wavelength than the others. This can be done with multiple dichroic cubes or other arrangements of dichroic elements.

Beneficially, the optical system 100 enables more efficient transmission of light in a desired state of polarization through the recycling of the light. In the example embodiment described above the light emitting elements 105-107 emit light that is unpolarized or randomly polarized. Moreover, the example embodiments improve the efficiency of each light-emitting element if it is initially unpolarized or only partially polarized.

FIG. 2 is an optical system 200 in accordance with an example embodiment. The optical system 200 is particularly useful in applications such as LCD systems in which it is advantageous to have the output light of the optical system 200 be polarized. Many of the elements and their functions are similar or substantially identical to the elements described in connection with the embodiment of FIG. 1. To the extent that it is practical, in the interest of clarity redundant descriptions of like elements and their functions are not repeated in the description of the embodiments of FIG. 2.

The optical system 200 includes a first optical element 201, a second optical element 202 and a third optical element 203. Each optical package includes an LED 211 that is disposed in a compound parabolic concentrator (CPC) 212. The LED 211 may also be an array of LED's such as described in the provisional application described above. It is also noted that greater lumen output can be achieved by a ‘larger’ LED chip. In an example embodiment, the LED's 211 of the optical elements 210, 202, and 203 emit light of a different wavelength range or wavelength, and thus different color. More particularly, one LED emits light that is green in color, one LED emits light that is red in color, and one LED emits light that is blue in color. This allows for the formation of images on a display surface (e.g., a television screen) after modulation of the light by the LCD material. Of course, other and additional colors (wavelengths) may be emitted by the LED's as desired in a given optical system.

Each of the optical elements 201, 202 and 203, have a reflective polarizer 204 disposed on a surface opposite the LED 211 as shown. The reflective polarizer 204 transmits light of one state of linear polarization and reflects light of a state of linear polarization that is orthogonal to that transmitted. The type and function of the reflective polarizers are as described in connection with the embodiments of FIG. 1. One or more of the optical elements 101, 102, 103 optionally include a QWP 205 disposed between the reflective polarizer 204 and the surface of the CPC 212 to improve the efficiency of the coupling of polarized light of a desired orientation from the LED's. Again, details of the function of the QWP are as described above in connection with the embodiments of FIG. 1.

Each CPC 212 is used for redirecting reflected light in much the same manner as described previously. The CPC 212 is an element known in the optical arts. For example, the CPC 212 may be of the type described the provisional application referenced above. One or more of the CPC 212 is usefully substantially solid and made from a suitable optical grade dielectric, such as optical grade glass. Alternatively, one or more of the CPC 212 may be substantially hollow having a reflective surface to reflect light back toward the reflective polarizer 204 and, if applicable, to the QWP 205. It is noted that if the CPC 212 is made of the dielectric as discussed, it may be useful to provide a reflective material on its surface, at least in the region proximate to the LED to improve the efficiency of the CPC 212. This reflective surface will foster reflection of light that is reflected from the reflective polarizer 205 back to the LED's 211 and/or the surface of the CPC 212 in a manner similar to that described previously.

The optical system 200 includes an optical element 214, which is illustratively a dichroic cube, such as described above. Of course, the optical element may be one or more of the dichroic elements described above to effect wavelength combination. The optical system 200 also includes an integrating rod 206 for coupling light from the optical element 214, which is illustratively a dichroic cube, or a combination of dichroic elements as referenced above. The light from the integrating rod is incident on a relay lens 207 and then on a polarizing beam splitter 208. Light is then reflected by the beam splitter 208 to an LCOS panel 209, or similar LCD device. This light is modulated by the LCOS panel 209 and is selectively transmitted to a projection lens 210 of a display device (not shown).

It is noted that the integrating rod 206 may be of the type described in U.S. Pat. No. 5,146,248, the above referenced provisional application, and the above referenced utility application, the inventions of which are assigned to the present assignee. The disclosure of the referenced patent is specifically incorporated by reference herein. Moreover, it is noted that the relay lens 207, the polarizing beamsplitter 208, the LCOS panel 209, the projection lens 210, and their functions in LCD projection systems are well known, and as such, are not discussed in further detail herein.

In accordance with an example embodiment, the LED 211 of the first optical element 201 emits red light 215, the LED 211 of the second optical element 202 emits green light 216 and the LED of the third optical element emits blue light 217. The light from the LED's is unpolarized, and the polarization components of this light are parallel and perpendicular to the polarization axis of the respective reflective polarizers 205 of the optical elements. The light that is polarized parallel to the polarization axis is transmitted to the dichroic cube and further in the optical system 200. All other light is reflected. Some of this light is incident on the LED 211 and is absorbed and re-emitted as unpolarized light as described above. This re-emitted light is then incident on the reflective polarizer, and the process continues as described previously.

Moreover, the light, which is not absorbed/re-emitted by the LED 211 has a polarization state that is orthogonal to the polarization axis of the reflective polarizer. This light is reflected by the CPC 212, and a significant portion of this light is incident upon the surface of the CPC 212 adjacent to the reflective polarizer 204. Because this light has traversed the QWP 205 twice, its polarization state is rotated by 90°, and is now parallel to the axis of the reflective polarizer 204. As such, much of the light that was initially reflected because of the orientation of its polarization vector is now transmitted to the optical element 214, and to the other elements of the optical system for further processing.

In accordance with the example embodiments of FIGS. 1 and 2, efficient recycling of light of an undesired polarization back to the optical emitter so that the net output of the optical emitter is transmitted to an optical system with the desired polarization, and without losing at least half of the optical energy from the optical emitter is effected. These and other benefits of the example embodiments will be readily apparent to one skilled in the art having had the benefit of the present disclosure.

FIG. 3 shows an optical element 300 in accordance with an example embodiment of the present invention. The optical element 300 includes a CPC 301 having a light-emitting element 302 disposed therein. The element 302 is illustratively an LED, an array of LED's, or other suitable device or array of devices. The array of LED's may be as described in the referenced provisional application. The CPC 301 is illustratively a substantially solid element made of a suitable optical-grade material such as an optical grade glass or other dielectric. At least a portion of the surface 303 is reflective, having a suitable material disposed thereon. Optionally, the optical element 300 may have a reflective polarizer 305, or a QWP 304, or both. These elements are as described above and are useful in improving the transmission efficiency of a light in a desired polarization state in a direction 306. The benefits of this are described in further detail previously.

Clearly, the optical element could be used as the optical elements of the example embodiments of FIGS. 1 and 2. Moreover, it is noted that the optical element 300 can be used in general to improve the coupling efficiency from a light-emitting device 302 in other applications as well. For example, in an example embodiment, the QWP 304 and reflective polarizer 305 are foregone, and light from the light emitting element, whether polarized, unpolarized or randomly polarized may be for efficiently coupled to within the acceptance angle of another optical element (note shown) than without the CPC 301. Moreover, the optical element 300 is a packaged device that is ready for use in a system, and includes some integrated optics.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. An optical system, comprising:
at least one light source, which emits light substantially of a particular wavelength range in a substantially randomly polarized or unpolarized state;
at least one reflective polarizer coupled to the at least one light source; and
at least one element that redirects a portion of light reflected by the reflective polarizer through the at least one light source and back to the at least one reflective polarizer,
wherein there is substantially no optical distance between the at least one light source and the at least one element.

2. The optical system as recited in claim 1, wherein the at least one light source is disposed in the element.

3. The optical system as recited in claim 2, wherein at least one light source is encased in a material of the element.

4. The optical system as recited in claim 3, wherein the at least one element is substantially solid.

5. The optical system as recited in claim 1, further comprising a quarter wave plate (QWP) disposed between the at least one reflective polarizer and the at least one element.

6. The optical system as recited in claim 1, wherein the at least one reflective polarizer is disposed over a surface of the at least one element.

7. The optical system as recited in claim 1, wherein the at least one element is a compound parabolic concentrator (CPC).

8. The optical system as recited in claim 1, further comprising a wavelength combiner disposed adjacent to the at least one optical element.

9. The optical system as recited in claim 8, further comprising an integrating rod that is optically coupled to a liquid crystal display (LCD) system.

10. The optical system as recited in claim 5, wherein another portion of the light reflected by the at least one reflective polarizer is reflected back to the at least one reflective polarizer by the element.

11. The optical system as recited in claim 8, wherein the wavelength combiner is chosen from the group consisting essentially of: a dichroic cube; a plurality of dichroic cubes; and dichroic elements.

12. The optical system as recited in claim 1, wherein the at least one light source is an array of light emitting diodes.

13. The optical system as recited in claim 1, wherein the at least one light source is a single LED.

14. The optical system as recited in claim 1, further comprising a plurality of the elements that redirect light, each of which includes: at least one of the at least one light sources; and one of the at least one reflective polarizers.

15. A method of recycling light to improve efficiency of an optical system, the method comprising:
providing at least one reflective polarizer and at least one source of unpolarized or randomly polarized light, where one of the reflective polarizers is coupled to each of the sources of unpolarized or randomly polarized light;
redirecting a portion of light reflected from the reflective polarizer through the light source and back to the reflective polarizer, which transmits light of a particular polarization state and reflects the remaining light to the element, wherein there is substantially no optical distance between the reflective polarizer and the element.

16. The method as recited in claim 15, the method further comprising polarizing at least a portion of the reflected light to the particular polarization state.

17. The method as recited in claim 15, the method further comprising combining light from at least two of the sources of unpolarized or randomly polarized light.

18. The method as recited in claim 16, the method further comprising polarizing directing the light of the particular polarization state to a liquid crystal device.

19. An optical package, comprising at least one light emitting element, which is disposed in an optical element, which redirects light reflected from one end of the element back through the light emitting device and out from the one end.

20. The optical package as recited in claim 19, wherein the light-emitting element emits randomly polarized light or unpolarized light of over a substantially finite wavelength range.

21. The optical package as recited in claim 19, wherein the at least one light-emitting element is chosen from the group consisting essentially of: a single light emitting diode and an array of light emitting diodes.

22. The optical package as recited in claim 19, wherein the light- emitting element is encased in the optical element.

23. The optical package as recited in claim 19, wherein the optical element is a compound parabolic combiner.
